(19) United States
(12) Patent Application Publication
(10) Pub. No.: US 2018/0086635 A1
(43) Pub. Date: Mar. 29, 2018

(54) PROCESS AND APPARATUS FOR STEAM REFORMING

(71) Applicant: Maximilian Jarosch, Munich (DE)

(72) Inventor: Maximilian Jarosch, Munich (DE)

(21) Appl. No.: 15/705,824

(22) Filed: Sep. 15, 2017

(30) Foreign Application Priority Data
Sep. 27, 2016 (DE) 10 2016 011 657.9

(51) Int. Cl. C01B 3/38; C01B 32/40; B01J 8/06

(52) U.S. Cl. CPC C01B 3/388; C01B 32/40; B01J 8/067; B01J 8/065; C01B 2203/0233; B01J 2208/065; C01B 2203/0811; C01B 2203/1252; C01B 2203/1241; C01B 2203/1294; C01B 2203/0833

(57) ABSTRACT

A process and an apparatus for generating a hydrogen- and/or carbon monoxide-comprising gas product, wherein a hydrocarbon feed formed from a hydrocarbons-containing starting material is supplied together with superheated steam to a steam reforming proceeding at elevated pressure to obtain a hydrogen- and carbon monoxide-containing crude synthesis gas from which the gas product is derived are disclosed. The boiler feed water is supplied at a pressure higher than its critical pressure with heat to obtain supercritical water of which subsequently at least a portion is employed as propelling medium in a steam jet ejector by means of which the hydrocarbon feed and/or a substance employed for the formation thereof are compressed.

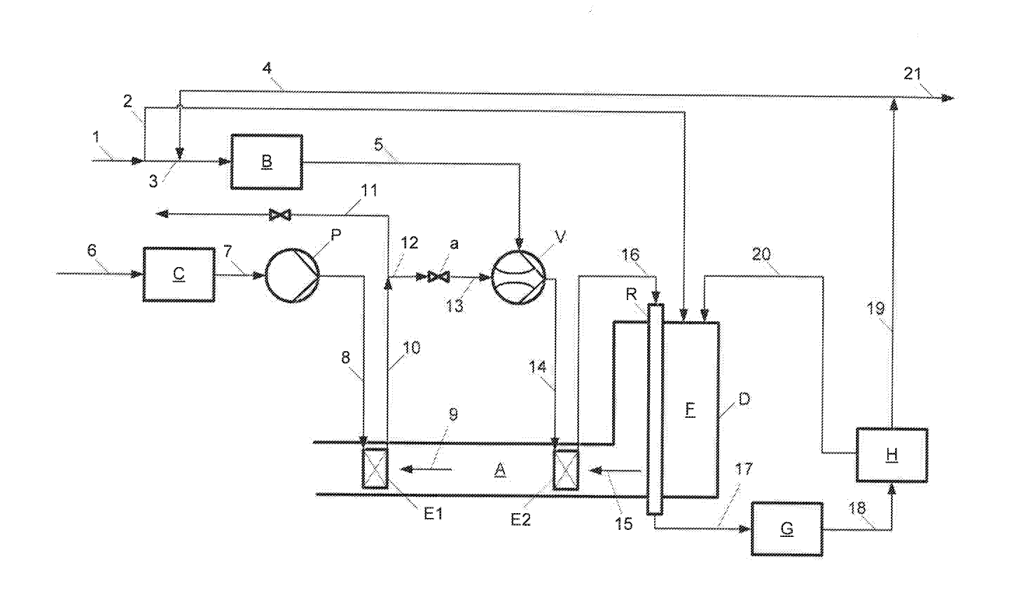

### CROSS REFERENCE TO RELATED APPLICATIONS

This application claims priority from German patent application DE 10 2016 011657.9 filed on Sep. 27, 2016.

### BACKGROUND OF THE INVENTION

The invention relates to a process for generating a hydrogen- and/or carbon monoxide-comprising gas product, wherein a hydrocarbon feed formed from a hydrocarbons-containing starting material is supplied together with superheated steam to a steam reforming proceeding at elevated pressure to obtain a hydrogen- and carbon monoxide-containing crude synthesis gas from which the gas product is derived.

The invention further relates to an apparatus for conducting the process according to the invention.

Steam reforming is the most widespread process for industrial generation of hydrogen-rich synthesis gas from light hydrocarbons. Here, hydrocarbons-containing starting materials (for example natural gas, liquefied gas or naphtha) are treated by removal of undesired substances such as sulfur and optionally by addition of material streams recycled inside the process to afford a feed (hydrocarbon feed) which together with process steam is passed through reformer tubes arranged in the firebox of a steam reformer. In the reformer tubes whose inner surfaces are catalytically active or which are completely or at least partly filled in the region of the firebox with a dumped bed of a suitable catalyst material or a catalytically active structured packing there is formed in an endothermic reforming reaction a hydrogen-rich, carbon monoxide-containing crude synthesis gas from which in subsequent process steps a hydrogen- and/or carbon monoxide-comprising gas product such as for example pure hydrogen is obtained.

The energy required for the reforming reaction is usually provided via burners which discharge their hot flue gases into the firebox. By radiation and convection the flue gases transfer a portion of the heat contained therein to the reformer tubes before in a cooled but still hot state being withdrawn via a flue gas channel in which a waste heat system consisting of a plurality of heat exchangers is arranged. Via the heat exchangers heat is further removed from the flue gases and utilized for example for preheating the starting materials or for generating process steam so that said gases have a temperature of merely between 120° C. and 200° C. when they are finally discharged into the atmosphere via a chimney.

The process steam employed is typically superheated steam, the generation of which according to the prior art comprises initially pumping boiler feed water into a steam drum. From the steam drum preheated water flows downward under gravity to a first heat exchanger arranged in the flue gas channel of the steam reformer and is there partly vaporized against flue gas that is to be cooled. On account of its lower density the liquid/steam mixture formed in the first heat exchanger ascends and arrives back in the steam drum in which a separation into liquid water and saturated steam having a pressure of about 48 bar(a) and a temperature of 260° C. for example takes place. The saturated steam is passed on to a second heat exchanger, likewise arranged in the flue gas channel of the steam reformer but upstream of the first heat exchanger, from which superheated steam can be withdrawn as process steam.

The steam drum may also be connected to a waste heat boiler known as a PGC (process gas cooler) in which boiler feed water is partly vaporized against hot crude synthesis gas effluxing from the reformer tubes.

The steam drum represents a significant cost factor since it must be implemented as a pressure vessel which entails complexity in configuration, production and monitoring. The required positioning of the steam drum above the flue gas channel of the steam reformer necessitates a stable scaffolding construction the costs of which are likewise attributable to the steam drum.

The hydrocarbons-containing starting material often has a pressure insufficient for direct supply to the steam reformer. In such a case the prior art employs a mechanical compressor to raise the pressure of the starting material.

Sulfur present in the hydrocarbons-containing starting material is a poison for the catalyst employed for steam reforming which is why the starting material must be treated by removal of the sulfur. To this end, the sulfur is hydrogenated to afford hydrogen sulfide which is subsequently removed by adsorption. For the hydrogenation hydrogen removed from the crude synthesis gas is generally recycled and admixed with the hydrocarbons-containing starting material upstream of the reactor employed for the hydrogenation. If the starting material has a higher pressure than the recycled hydrogen then the recycled material stream must be compressed, to which end the prior art likewise employs a mechanical compressor.

Mechanical compressors are expensive in terms of capital and operating costs. Since moreover they also have a comparatively high failure rate and are therefore implemented with redundancy they have a markedly negative effect on the economy of a steam reforming.

### SUMMARY OF THE INVENTION

The problem addressed by the present invention is that of providing a process and an apparatus of the type in question by means of which the disadvantages of the prior art are overcome in order thus to improve the economy of steam reforming.

This problem is solved when boiler feed water is supplied at a pressure higher than its critical pressure with heat to obtain supercritical water of which subsequently at least a portion is employed as propelling medium in a steam jet ejector by means of which the hydrocarbon feed and/or a substance employed for the formation thereof are compressed.

The proposed process makes it possible to completely eschew failure-prone, expensive and usually redundantly implemented machines for compression of the hydrocarbon feed and/or a substance employed for the formation thereof, for example recycled hydrogen. Steam jet ejectors have been prior art for many years and are known to a person skilled in the art. They have a relatively simple construction without moving parts and are robust so that they may be employed at markedly reduced costs compared to the mechanical compressors employed according to the prior art.

The portion of the supercritical water employed as propelling medium is decompressed either via a throttling means arranged upstream of the steam jet ejector or in the propelling nozzle of the steam jet ejector into superheated steam, the pressure energy of which is converted into kinetic energy. The steam jet ejector is advantageously configured and operated such that the superheated steam has a static pressure downstream of the propelling nozzle that is lower than the aspiration pressure of the hydrocarbon feed and/or the substance used to form the hydrocarbon feed, which are therefore aspirated and accelerated by the steam jet exiting the propelling nozzle. In the inlet cone of the diffuser which follows the propelling nozzle the steam and the aspirated substances undergo mixing before being decelerated again in the diffuser. Since pressure energy is recovered by the deceleration the aspirated substances leave the steam jet ejector together with the superheated steam at a pressure higher than their aspiration pressure.

It is preferable when the pressure, temperature and mass flow of the supercritical water employed as propelling medium are chosen such that during compression of the hydrocarbon feed in the steam jet ejector a substance mixture is formed which meets the requirements of steam reforming on account of its composition and/or has a pressure allowing supply to the steam reforming without further compression.

To generate the supercritical water a first portion of the boiler feed water may be heated against a hot flue gas which is supplied for instance from the firebox of the steam reformer used for steam reforming where it has already given off a portion of its sensible heat for the endothermic reforming reaction proceeding in the reformer tubes arranged there while a second portion of the boiler feed water is heated against hot crude synthesis gas effluxing from the steam reformer. However, it is preferable when the entirety of the boiler feed water is heated in heat exchange with hot flue gas effluxing from the steam reformer. In this case it is advantageous when the heat of the hot crude synthesis gas is used to preheat the combustion air for burners employed in the steam reformer and/or to superheat the substance mixture obtained upon compression in the steam jet ejector before it is supplied to the steam reforming. Superheating of the substance mixture obtained in the steam jet ejector may alternatively or in addition also be achieved against a hot flue gas which is preferably a flue gas effluxing from the firebox of the steam reformer used for steam reforming which is subsequently used for generating the supercritical water.

The plant components used for generating the supercritical water give rise to comparatively high costs since they must be manufactured from highly alloyed special steels to withstand the severe demands placed on them in operation which increase in particular with the maximum pressure of the supercritical water. To limit the costs of steam reforming it is proposed to generate the supercritical water at a pressure of not more than 20 bar higher than the critical pressure of the boiler feed water which is at about 220 bar(a).

In some cases more heat may be available at a suitable temperature level for generating the supercritical water than is required for producing the superheated steam employed as process steam. In this case one variant of the process according to the invention provides for employing the entirety of the available heat for generating supercritical water and for exporting the portion not required for providing process steam in order to use it for power generation and/or heating purposes and/or for performing chemical reactions and/or as an extractant and/or for destroying toxic substances. A further embodiment of the process according to the invention provides for heating the portion of the supercritical water designated for export higher than the portion provided for deriving process steam, to which end flue gas from the firebox of the steam reformer or hot crude synthesis gas is preferably employed.

The process according to the invention may be used to obtain a carbon monoxide-and/or hydrogen-comprising gas product from a multiplicity of hydrocarbons-containing starting materials such as natural gas, liquefied gas or naptha by steam reforming.

The invention further relates to an apparatus for generating a hydrogen- and/or carbon monoxide-comprising gas product from a hydrocarbon feed formed from a hydrocarbons-containing starting material, comprising a steam reformer and a system for process steam generation from boiler feed water.

The problem addressed is solved when the system for process steam generation comprises a once-through boiler operable in the supercritical range whose superheater is connected to a steam jet ejector so that supercritical water generable in the superheater can be used as propelling medium in the steam jet ejector for compressing the hydrocarbon feed and/or a substance employed for the formation thereof.

The steam reformer preferably comprises a burner-fired firebox having reformer tubes arranged therein and a flue gas channel above which cooled but still hot flue gases can be withdrawn from the firebox. The once-through boiler is advantageously arranged in the flue gas channel of the steam reformer so that the heat from the flue gases withdrawn from the firebox is utilizable for generating the supercritical water.

### BRIEF DESCRIPTION OF THE DRAWINGS

The invention is to be more particularly elucidated hereinafter with reference to a working example shown in schematic form in the FIGURE.

The FIGURE shows a plant in which pure hydrogen is derived as a gas product from a hydrocarbons-containing starting material by steam reforming.

### DETAILED DESCRIPTION OF THE INVENTION

A hydrocarbons-containing starting material 1, for example natural gas, vaporized liquefied gas or naphtha, is divided into a first substream 2 and a second substream 3. While the first substream 2 is supplied as fuel to the steam reformer D for heating the firebox F the second substream 3 is mixed with recycled hydrogen 4 and introduced into the treatment means B to remove substances such as sulfur compounds which would result in failures in the downstream plant parts and to provide a hydrocarbon feed 5 for the steam reformer D. Since the pressure of the hydrocarbon feed 5 is too low for direct introduction into the steam reformer D operated at about 20-30 bar(a) it is supplied to the steam jet ejector V to increase the pressure.

To generate process steam demineralized water 6 is passed into the treatment means C to be degassed and treated to afford boiler feed water 7. The boiler feed water 7 which is under slight positive pressure is subsequently brought by means of the boiler feed water pump P to a pressure up to 20 bar above its critical pressure and via conduit 8 supplied to the heat exchanger E1 arranged in the flue gas channel A of the steam reformer D where in indirect heat exchange with hot flue gas 9 supercritical water 10 is formed. A portion 11 of the supercritical water 10 is exported and may be utilized for example for power generation in a steam turbine (not shown). By contrast, the remainder 12 of the supercritical water 10 is decompressed via the throttling means a to form superheated steam 13 which is employed as propelling medium in the steam jet ejector V to bring the hydrocarbon feed 5 to the pressure required for steam reforming while simultaneously effecting intensive mixing thereof with the propelling medium which serves as process steam. The supercritical water 10 is preferably generated at a pressure and a temperature which make it possible to supply the superheated steam 13 to the steam jet ejector P with the entirety of the process steam required for the steam reforming so that the material stream 14 leaving the steam jet ejector V without any further alteration of its composition and merely after superheating against hot flue gas 15 in the second heat exchanger E2 arranged upstream of the first heat exchanger E1 may be introduced as superheated feed 16 into the reformer tubes R of the steam reformer D.

From the hydrogen-rich crude synthesis gas 17 generated in the reformer tubes R by steam reforming, in the purification means G by removal in particular of water and carbon monoxide a synthesis gas 18 consisting largely of hydrogen and carbon monoxide is generated which in the pressure swing adsorber W is resolved into pure hydrogen 19 and a residual gas 20 consisting predominantly of carbon monoxide. While the residual gas 20 is burned in the firebox F of the steam reformer D to provide energy for the reforming reaction the larger part of the pure hydrogen 19 is discharged as gas product 21 and the smaller part 4 is recycled upstream of the treatment means B into the second substream 3 of the starting material 1.

What I claim is:

1. A process for generating a hydrogen- and/or carbon monoxide-comprising gas product, wherein a hydrocarbon feed formed from a hydrocarbons-containing starting material is supplied together with superheated steam to a steam reforming proceeding at elevated pressure to obtain a hydrogen- and carbon monoxide-containing crude synthesis gas from which the gas product is derived, characterized in that boiler feed water is supplied at a pressure higher than its critical pressure with heat to obtain supercritical water of which subsequently at least a portion is employed as propelling medium in a steam jet ejector by means of which the hydrocarbon feed and/or a substance employed for the formation thereof are compressed.

2. The process according to claim 1, characterized in that during compression of the hydrocarbon feed in the steam jet ejector a substance mixture is formed which meets the requirements of steam reforming on account of its composition and/or has a pressure allowing supply to the steam reforming without further compression.

3. The process according to claim 1, characterized in that the boiler feed water is heated in indirect heat exchange against flue gas from which heat is removed beforehand for the steam reforming.

4. The process according to claim 1, characterized in that the substance mixture formed during compression of the hydrocarbon feed in the steam jet ejector is heated in indirect heat exchange against flue gas from which heat is removed beforehand for the steam reforming reaction.

5. The process according to claim 1, characterized in that supercritical water is generated at a pressure not more than 20 bar higher than the critical pressure of the boiler feed water.

6. The process according to claim 1, characterized in that a portion of the supercritical water not required as propelling medium for the steam jet ejector is exported and used for a process selected from the group consisting of generating electrical power, for heating purposes, for performing chemical reactions, as an extractant, and for destroying toxic substances.

7. The process according to claim 6, characterized in that before export the portion of the supercritical water not required as propelling medium for a steam jet ejector is heated further against flue gas that is to be cooled.

8. The process according to claim 1, characterized in that natural gas or vaporized liquefied gas or vaporized naphtha is used as the hydrocarbons-containing starting material.

9. An apparatus for generating a hydrogen- and/or carbon monoxide-comprising gas product from a hydrocarbon feed formed from a hydrocarbons-containing starting material, comprising a steam reformer and a system for process steam generation from boiler feed water, characterized in that the system for process steam generation comprises a once-through boiler operable in the supercritical range whose superheater is connected via a throttling means to a steam jet ejector so that supercritical water generable in the superheater can be used as propelling medium in the steam jet ejector for compressing the hydrocarbon feed and/or a substance employed for the formation thereof.

10. The apparatus according to claim 9, characterized in that the once-through boiler is arranged in the flue gas channel of the steam reformer.
